(19) United States
(12) Patent Application Publication
(10) Pub. No.: US 2013/0070246 A1
(43) Pub. Date: Mar. 21, 2013

(54) OPTICAL DETECTION APPARATUS

(71) Applicants: Dar-Bin SHIEH, Tainan City (TW); Pau-Choo CHUNG, Tainan City (TW)

(72) Inventors: Dar-Bin SHIEH, Tainan City (TW); Pau-Choo CHUNG, Tainan City (TW)

(21) Appl. No.: 13/613,463

(22) Filed: Sep. 13, 2012

(30) Foreign Application Priority Data
Sep. 20, 2011 (TW) 100133766

(51) Int. Cl. G01J 3/00

(52) U.S. Cl. 356/402

(57) ABSTRACT

An optical detection apparatus used for detecting a tissue includes a light-emitting unit, a spectroscopic unit and a light-sensing array. The light-emitting unit emits light entering into the tissue. The spectroscopic unit receives the light outputted from the tissue and divides the received light into a plurality of rays with different wavelengths. The light-sensing array senses the rays outputted from the spectroscopic unit so as to generate an array spectrum. By the spectroscopic unit, the detection of the rays of multiple wavelengths can be performed without using plural light-emitting diodes for emitting light of different wavelengths. Besides, the user can perceive the detection result (e.g. the location of the abnormal tissue) intuitively by integrating the light-sensing array and the spectroscopic unit.

### CROSS REFERENCE TO RELATED APPLICATIONS

This Non-provisional application claims priority under 35 U.S.C. §119(a) on Patent Application No(s). 100133766 filed in Taiwan. Republic of China on Sep. 20, 2011, the entire contents of which are hereby incorporated by reference.

### BACKGROUND OF THE INVENTION

1. Field of Invention

The invention relates to a detection apparatus and, in particular, to an optical detection apparatus.

2. Related Art

With the progress of technologies, more and more the non-invasive detections have been used to replace the conventional invasive detections in the medical field. The non-invasive detection includes, for example, detecting the tissue of the human body by illuminating the human body by infrared (IR) and then sensing the light outputted from the human body.

As shown in FIG. 1, a conventional optical detection apparatus 1 includes a light-emitting unit 11 and a light-sensing element 12. The light-emitting unit 11 includes a plurality of light-emitting diodes (LEDs) that can emit light of different wavelengths. The light emitted can enter into the human body and pass through the tissue by diffraction, scattering and reflection in the tissue. Then, the light outputted from the tissue can be received by the light-sensing element 12. The light-sensing element 12 transforms the light to an electrical signal for the following signal analysis. Finally, it can be obtained whether the tissue of the detected human is normal or not through the signal analysis.

Nevertheless, in the prior art, several LEDs are needed for providing the light of different wavelengths, and the LEDs need to take turns emitting light to prevent mutual disturbance or crosstalk. Accordingly, the electrical signal, which is transformed from the light, needs to he analyzed in time domain, resulting in the slower analysis rate. Besides, the operators can not view the detection result intuitively, but only be informed by whether it's normal or not.

Therefore, it is an important subject to provide an optical detection apparatus that can enhance detection efficiency and provide intuitive and perceivable detection result.

### SUMMARY OF THE INVENTION

In view of the foregoing subject, an objective of the invention is to provide an optical detection apparatus that can enhance detection efficiency and provide intuitive and perceivable detection result.

To achieve the above objective, the present invention discloses an optical detection apparatus for detecting a tissue, which includes a light-emitting unit, a spectroscopic unit and a light-sensing array. The light-emitting unit emits light entering into the tissue. The spectroscopic unit receives the light outputted from the tissue and divides the received light to a plurality of rays with different wavelengths. The light-sensing array senses the rays outputted from the spectroscopic unit so as to generate an array spectrum.

in one embodiment, the light-emitting unit is a broadband spectrum light-emitting unit and, preferably, the wavelength of the light emitted by the light-emitting unit is between 300 nm and 2000 nm.

In one embodiment, the optical detection apparatus further includes a first light-guiding unit which guides the light emitted by the light-emitting unit to the tissue. The first light-guiding unit can include at least one optical fiber. Accordingly, the loss of the light emitted by the light-emitting unit can be avoided so as to keep the light strength entering into the tissue, thereby achieving more accurate detection.

In one embodiment, the spectroscopic unit includes a spectroscopic prism, a filter unit, acousto-optic tunable filter (AOTF) or a liquid crystal tunable filter (LCTF).

In one embodiment, the optical detection apparatus further includes a second light-guiding unit which guides the light outputted from the tissue to the spectroscopic unit. The spectroscopic unit divides the received light to generate the rays of different wavelengths and transmits the rays to the light-sensing array. The second light-guiding unit can include a plurality of optical fibers. By the second light-guiding unit, the detection can be implemented to the specific locations so as to enhance the detection accuracy.

In one embodiment, the light-sensing array includes a plurality of light-sensing elements forming an array. The light-sensing element includes a photodiode, a photoresistor or a photomultiplier tube. The photodiode is, for example, a charge-coupled device (CCD) or a complementary metal-oxide-semiconductor (CMOS) device, The photoresistor is, for example, cadmium sulfide (CdS) light-sensing element.

In one embodiment, an axis of the array spectrum represents positions, and the other axis of the array spectrum represents wavelengths.

In one embodiment, the optical detection apparatus further includes another spectroscopic unit which receives the light outputted from the tissue, divides the received light to generate a plurality of rays with different wavelengths, and then transmits the rays to the light-sensing array or another light-sensing array.

In one embodiment, the optical detection apparatus further includes a tissue detection unit for detecting the tissue.

In one embodiment, the optical detection apparatus further includes a signal transforming unit which receives the light-sensing signal generated by the light-sensing array and transforms it to the display signal.

As mentioned above, in the optical detection apparatus of the invention, the spectroscopic unit can generate the rays with different wavelengths from the received light, such as expanding the light to a spectrum of a certain waveband or picking out some rays of different wavelengths. Accordingly, the multi-wavelength detection can be achieved without using several LEDs for emitting lights of different wavelengths. Furthermore, the rays of different wavelengths are provided by the cooperation of the light-emitting unit and the spectroscopic unit, so that it is unnecessary to analyze the light-sensing signal in time domain. Besides, because the light-emitting unit emits the light continuously, the rays of different wavelengths can be generated in “real time” and transmitted to the light-sensing array by the spectroscopic unit, thereby improving the detection efficiency. Additionally, the light-sensing array senses the rays from the spectroscopic unit and forms an array spectrum which can be perceived with an intuitive detection result. For instance, by viewing the array spectrum (near infrared glasses may be needed) or the pseudo colors corresponding to the array spectrum, the operator can know whether an abnormal tissue exists as well as the location and kind of the tissue.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a conventional optical detection apparatus;

FIG. 2 is a schematic diagram of an optical detection apparatus according to a preferred embodiment of the invention;

FIG. 3 is an image of an array spectrum displayed on the light-sensing array of the optical detection apparatus according to a preferred embodiment of the invention;

FIG. 4 is a top view of another aspect of the invention, wherein the optical fibers disposed to the tissue have a radial pattern;

FIG. 5 is a block diagram of the optical detection apparatus according to the preferred embodiment of the invention;

FIGS. 6 and 7 are schematic views of various aspects of the optical detection apparatus according to an preferred embodiment of the invention; and

FIG. 8 is a schematic view showing the appearance of the optical detection apparatus according to the preferred embodiment of the invention.

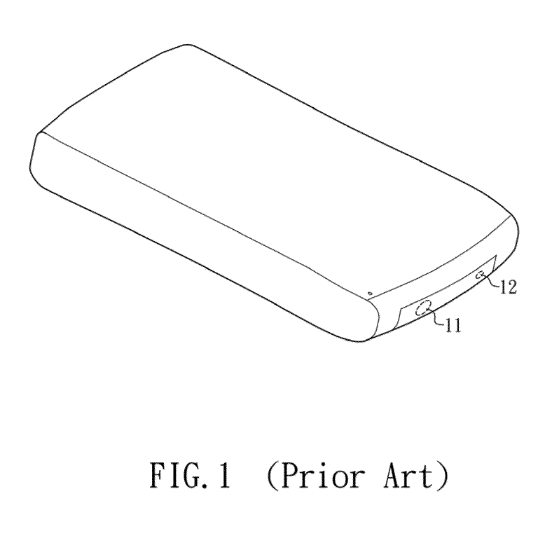

### DETAILED DESCRIPTION OF THE INVENTION

The present invention will be apparent from the following detailed description, which proceeds with reference to the accompanying drawings, wherein the same references relate to the same elements.

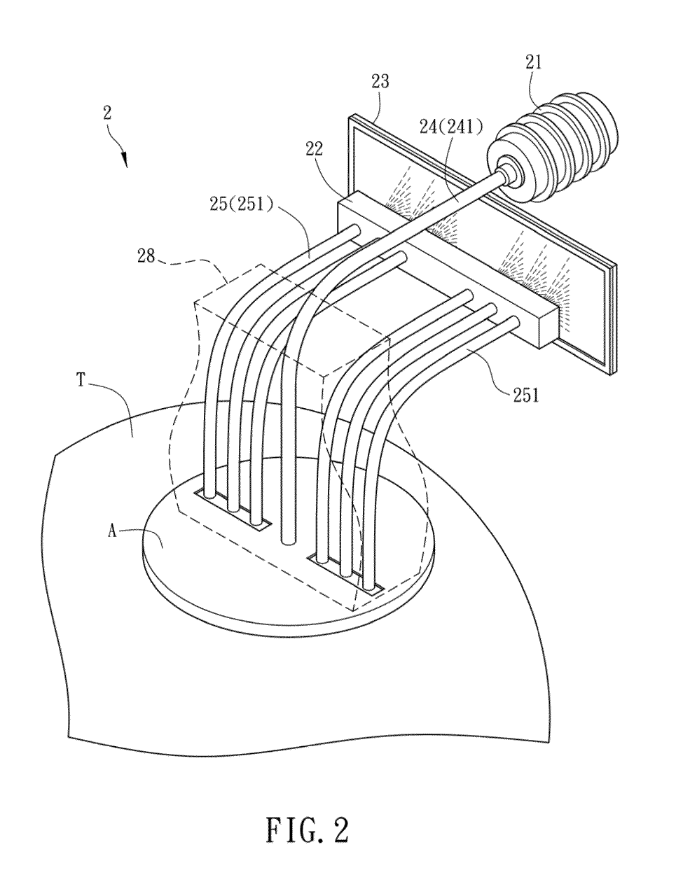

FIG. 2 is a schematic diagram of an optical detection apparatus 2 according to a preferred embodiment of the invention. The optical detection apparatus 2 is used to detect a tissue T, for example, of a human, an animal, a plant or medicine. Herein, the tissue T is sampled from a human breast for example. The optical detection apparatus 2 can detect the location and the type of the abnormal tissue and whether a tumor, a cancer or other abnormal tissues exist in the breast or not.

The optical detection apparatus 2 includes a light-emitting unit 21, a spectroscopic unit 22 and a light-sensing array 23. The light-emitting unit 21 can include a light-emitting device. The light emitted by the light-emitting unit 21 has waveband, for example, between 300 nm and 2000 nm covering the visible light and near infrared (NIR), and preferably between 350 nm and 1100 nm. The waveband as mentioned above is just for illustration as an example only, and is not for limiting the scope of the invention. The light of a certain waveband can be provided by a single light-emitting device, or by a plurality of light-emitting devices which are disposed in the light-emitting unit 21 and emit the rays of different wavelengths mixed by a light-mixing element. The light-emitting device is, fir example, an LED or a laser diode.

The optical detection apparatus 2 can further include a first light-guiding unit 24 which guides the light emitted by the light-emitting unit 21 to the tissue T. The first light-guiding unit 24 can avoid the loss of the light emitted by the light-emitting unit 21 to keep the light strength. The first light-guiding unit 24 can include, for example, at least one optical fiber 241 or a light-guiding bar. After being emitted by the light-emitting unit 21 and entering into the tissue T through the first light-guiding unit 24, the light is diffracted, scattered or reflected in the tissue T, and then exits the tissue T. Otherwise, the light may excite the tissue T to emit light, or cause the neighboring tissue to emit light.

Alternatively, in the case of without the first light-guiding unit 24, the light-emitting unit 21 can approach the tissue T as close as possible for decreasing the loss of the light.

The spectroscopic unit 22 receives the light outputted from the tissue T and divides the received light to generate a plurality of rays of different wavelengths. The spectroscopic unit 22 can include a spectroscopic prism, a filter unit, an acousto-optic tunable filter (AOTF) or a liquid crystal tunable filter (LCTF). The spectroscopic unit 22 can optionally pick some rays of discrete wavelengths from the light, or expand the light to the rays of a continuous waveband. Herein, the spectroscopic unit 22 is a spectroscopic prism for example, which expands the light emitted by the light-emitting unit 21 to a spectrum of a waveband.

The optical detection apparatus 2 can further include a second light-guiding unit 25 which guides the light outputted from the tissue T to the spectroscopic unit 22. Then, the spectroscopic unit 22 divides the light guided by the second light-guiding unit 25 to generate the rays of different wavelengths. The second light-guiding unit 25 can include a plurality of optical fibers 251 or light-guiding bars. In the embodiment, the second light-guiding unit 25 includes 6 optical fibers 251 for example. The detection area can be converged to a point by the optical fiber 251, thereby providing more accurate analysis and location of the abnormal tissue. In the embodiment, the optical fibers 251 and the optical fiber 241 are arranged in a row, and the detection area is thus limited to one dimension so as to enhance the detection accuracy. In this case, the two-dimensional scan and detection can be achieved as long as the operator moves the optical fibers 251 and 241.

Otherwise, in the case of without the second light-guiding unit 25, the spectroscopic unit 22 can approach the tissue T as close as possible for decreasing the loss of the light outputted from the tissue T.

The second light-emitting unit 25 passes through a light-shielding element A which can prevent undesired light from entering into the tissue T, thereby avoiding the signal interference. The light-shielding element A can be integrated to the portion of the shell of the optical detection apparatus 2 close to the light-emitting unit 21.

The light-sensing array 23 senses the light outputted from the spectroscopic unit 22, The light-sensing array 23 can include a plurality of light-sensing elements. which can include, for example, a photodiode, a photoresistor or a photomultiplier tube. The photodiode is such as a charge-coupled device (CCD) or a complementary metal-oxide-semiconductor (CMOS) device. The photoresistor is such as a cadmium sulfide (CdS) light-sensing element. The spectroscopic unit 22 expands the light to a spectrum of a waveband, and besides, the light spectrum is projected to the light-sensing array 23. So, the light-sensing elements of the light-sensing array 23 can produce an array spectrum by sensing the light. The array spectrum completely shows the spectrum and provides an intuitive detection result when been viewed by the operator.

To be noted, the light-sensing element of the light-sensing array 23 is preferably carried out by a CCD or a CMOS device, which is advantageous to obtaining two-dimensional optical signals for aiding to form the array spectrum. Based on the sensing output of the CCD or CMOS device, wide-field spectrum analyses for different locations can be implemented simultaneously according to the style of two-dimensional pixel array, which facilitates the whole operation. Further, the CCD and CMOS device have functions of quantitative light-sensing and specific area coverage of image obtained through scanning.

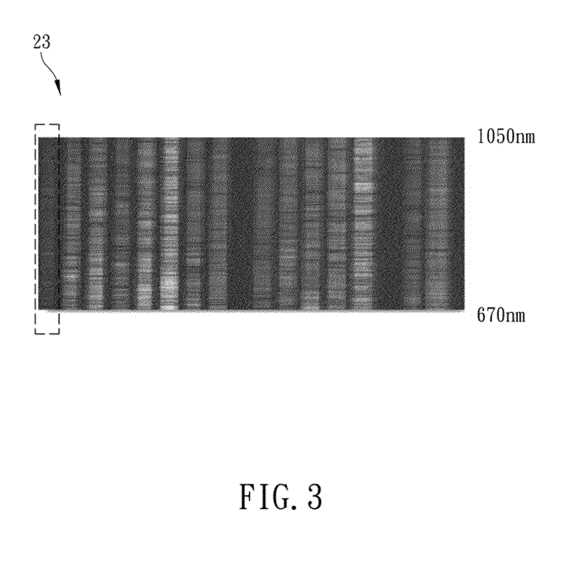

FIG. 3 is an image of an array spectrum displayed by the light-sensing array 23. The array spectrum includes a plurality of bars, each of which represents the sub-spectrum of the light that is from an optical fiber 251 and expanded by the spectroscopic unit 22 with a waveband between 670 nm and 1050 nm for example. An axis of the array spectrum represents positions (the positions of the optical fibers 251), and the other axis of the array spectrum represents wavelengths. To be noted, the array spectrum as shown in FIG. 3 is an example where the spectroscopic unit 22 expands the light of more than 6 optical fibers 251 to a spectrum with a waveband between 670 nm and 1050 nm.

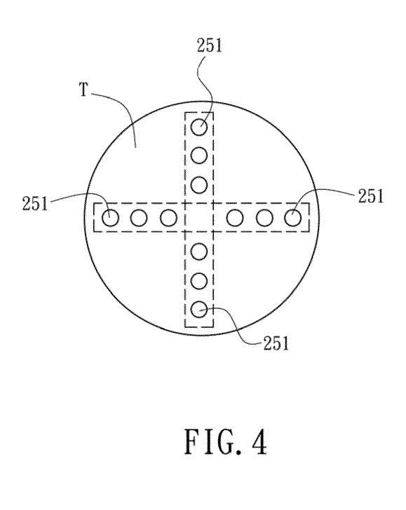

The optical fibers as shown in FIG. 2 arranged in one dimension are just for instance, and they can be configured in various patterns. for example, as shown in FIG. 4, a top view showing the optical fibers 251 of the second light-guiding unit are disposed around the tissue T, and the optical fibers 251 have a radial pattern.

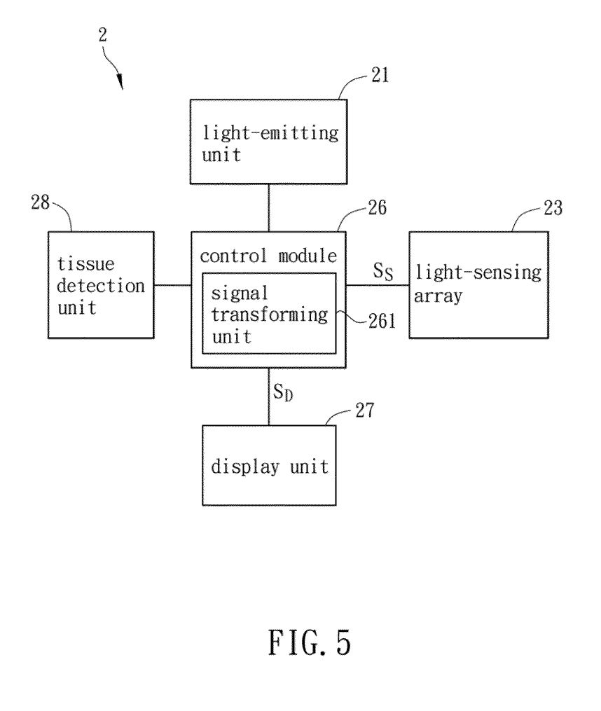

FIG. 5 is a block diagram of an embedment of the optical detection apparatus 2. The optical detection apparatus 2 can further include a control module 26, a display unit 27 and a tissue detection unit 28. The control module 26 is electrically connected with the light-emitting unit 21, the light-sensing array 23, the display unit 27 and the tissue detection unit 28. The detection procedure will be illustrated as below by referring to FIG. 5 and FIG. 2.

The control module 26 drives the light-emitting unit 21 to emit the light. The light-emitting unit 21 can be driven to continuously emit the light. The light emitted by the light-emitting unit 21 reaches the spectroscopic unit 22 through the first light-guiding unit 24, the tissue I and the second light-guiding unit 25. The spectroscopic unit 22 expands the light to a spectrum of a certain waveband that is transmitted to the light-sensing array 23. The light-sensing elements, arranged in two dimensions, of the light-sensing array 23 sense the light, and the light is transformed to the light-sensing signal SS that is transmitted to the control module 26. Additionally, before being transmitted to the control module 26, the light-sensing signal SS can be amplified for example. Thereafter, a signal transforming unit 261 of the control module 26 can transform the light-sensing signal to the display signal SD. The control module 26 drives the display unit 27 to display according to the display signal SD. Therefore, when the detector moves the optical fibers 241 and 251, the display unit 27 can display the real time detection result so as to provide the immediate and intuitive detection effect.

The display unit 27 can be a display panel corresponding to the light-sensing array 23. “Corresponding” means, for example, the amount of the pixels of the display panel may be unequal to that of the light-sensing array 23, but the pixels of the display panel can be in proportion to those of the light-sensing array 23. The display unit 27 can display a plurality of pseudo colors to represent the rays of different wavelengths and the different light strength. In this way, when a person (such as a doctor) views the display unit 27 showing the two-dimensional colors, the detection result can be intuitively perceived. On the other hand, the pseudo colors displayed by the display unit 27 can also reflect the existence probability of the abnormal tissue. For example, red represents very strong probability, blue represents not strong probability, and green represents zero probability. Furthermore, the pseudo colors displayed by the display unit 27 can also reflect the kind of the abnormal tissue. For example, red represents cancer cells, and green represents benign tumors. The relation between the image displayed by the display unit 27 and the light-sensing signal as mentioned above is just for illustration as an example, not for limiting the scope of the invention.

Except for presenting the detection result by the display unit 27, the detection result also can be presented by various ways. For example, the detection result can be read out by a speaker, or presented by varied flash frequency or brightness of the display unit 27 or a strobe. Instead of showing the detection result by the display unit 27, the user can directly view the image of the light-sensing array 23 by wearing NIR glasses to ascertain the result, which is very intuitive.

The light-sensing signal SS of the light-sensing array 23 can be drawn out for further analysis. By analyzing the light-sensing signal SS of the light-sensing elements arranged in two dimensions, the kind, size and location of the abnormal tissue can be ascertained.

As shown in FIGS. 2 and 5, the optical detection apparatus 2 can further include a tissue detection unit 28 which is electrically connected to the control module 26. The tissue detection unit 28 can be OCT (Optical Coherence Tomography), HGT, PAT or supersonic detection apparatus for example. The tissue detection unit 28 is a supersonic detection apparatus in the embodiment. The detection result of the supersonic detection apparatus and the light-sensing signal of the light-sensing array 23 can be analyzed separately or together to achieve more accurate and various effects. In structure, the tissue detection unit 28 can be integrated with the second light-guiding unit 25. For example, the optical fiber 251 passes through the tissue detection unit 28 so that the whole structure can be simplified with a lovely appearance. Besides, when the tissue detection unit 28 is moved, the second light-guiding unit 25 is moved together, so that the light-sensing array 23 and the tissue detection unit 28 can detect the same area at the same time. Of course, in practice, the tissue detection unit 28 can be a separate part.

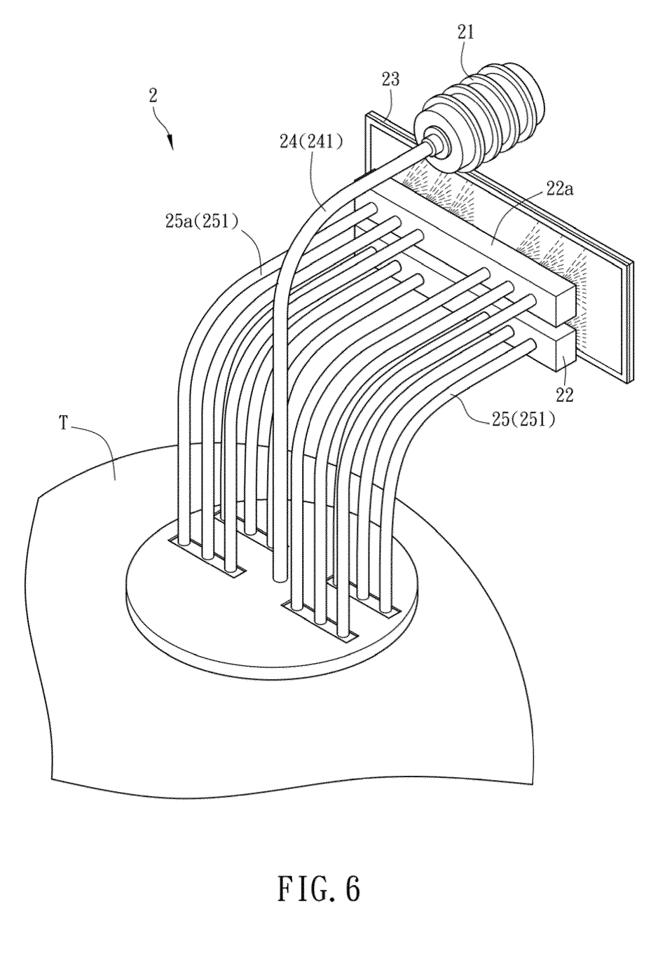

Various aspects of the optical detection apparatus 2 are further illustrated as below. As shown in FIG. 6, the optical detection apparatus 2 can further include another spectroscopic unit 22a, which receives the light outputted from the tissue T and thus generates a plurality of rays of different wavelengths, which are then transmitted to the light-sensing array 23. Herein, the spectroscopic unit 22a is disposed above the spectroscopic unit 22, and the rays generated by the spectroscopic units 22a and 22 are projected to different areas (such as an upper portion and a lower portion) and sensed. The optical detection apparatus 2 can further include another second light-guiding unit 25a, which is similar to the second light-guiding unit 25 and includes a plurality of optical fibers 251 guiding the light outputted from the tissue T to the spectroscopic unit 22a. Therefore, the light-sensing array 23 can show the detection result of two areas. In this way, the detection of more areas or overall area can be achieved, and the detection result is also very intuitive and perceivable. Preferably, the rays of the spectroscopic units 22 and 22a can't interfere with each other. In the embodiment, the optical fiber 241 is disposed between the light-guiding units 25 and 25a.

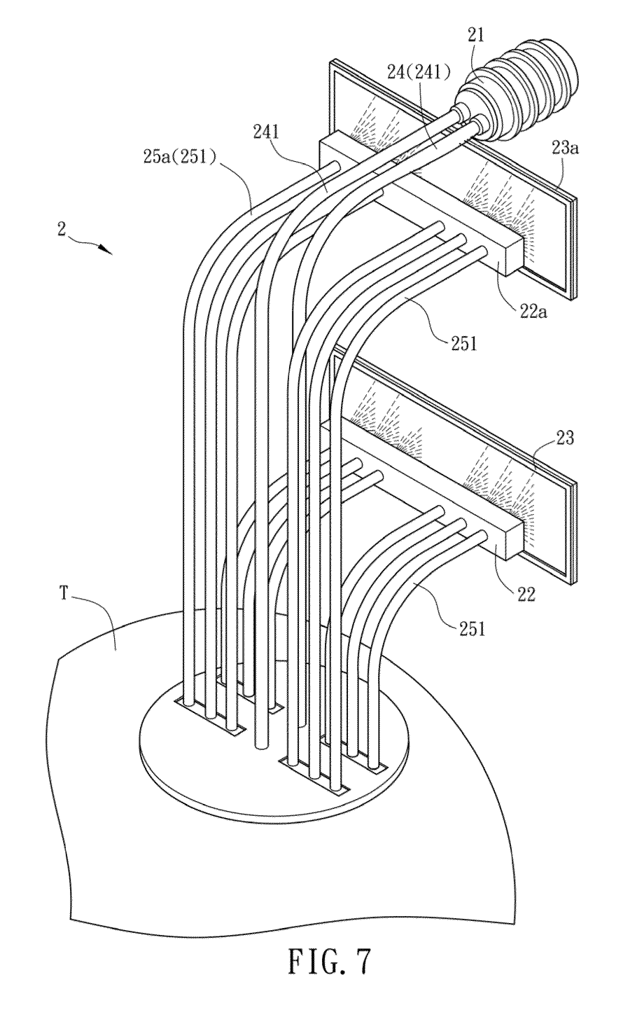

As shown in FIG. 7, the optical detection apparatus 2 can further include another light-sensing array 23a, which includes a plurality of light-sensing elements forming an array. As shown in FIG. 7, the spectroscopic unit 22a projects the rays to the light-sensing array 23a. The first light-guiding unit 24 of the optical detection apparatus 2 includes another optical fiber 241. The light outputted from the optical fibers 241 are corresponding to the second light-guiding units 25 and 25a, respectively. In this way, the detection of more areas or overall area can be achieved, and the detection result is also intuitive and perceivable.

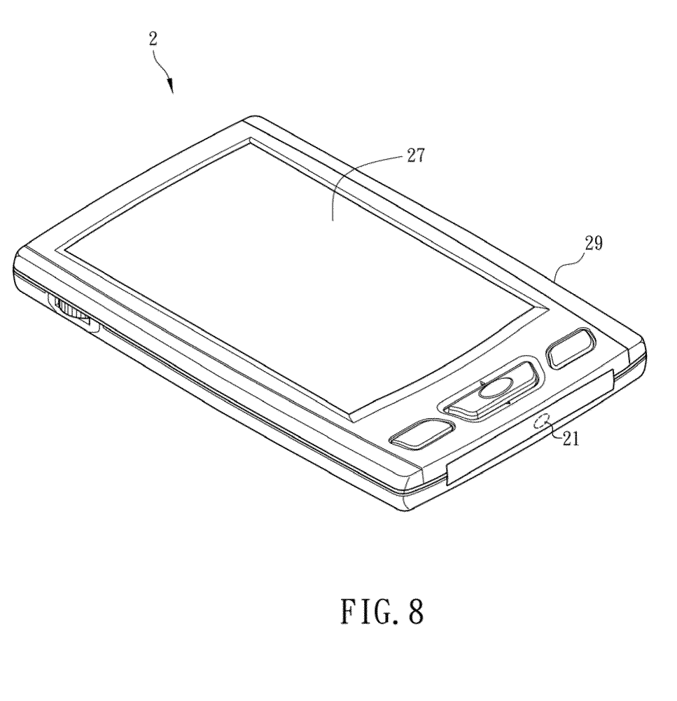

As shown in FIG. 8, another possible aspect of the optical detection apparatus 2 is instantiated by a smart phone. The light-emitting unit 21 of the optical detection apparatus 2 is disposed at the bottom of a casing 29 of the optical detection apparatus 2. The spectroscopic unit 22 and the light-sensing array 23 are disposed inside the casing 29. Because the operator usually holds the optical detection apparatus 2 and moves it to approach the body for the detection, the first and second light-guiding units 24 and 25 are unnecessary in the optical detection apparatus 2. During the detection, the detection result is directly shown on the display unit 27 and presented by images full of two-dimensional colors for example, so that the user can intuitively perceive the detection result.

In summary, in the optical detection apparatus of the invention, the spectroscopic unit can generate the rays with different wavelengths from the received light, such as expanding the light to a spectrum of a certain waveband or picking out some rays of different wavelengths. Accordingly, the multi-wavelength detection can be achieved without using several LEDs for emitting lights of different wavelengths. Furthermore, the rays of different wavelengths are provided by the cooperation of the light-emitting unit and the spectroscopic unit, so that it is unnecessary to analyze the light-sensing signal in time domain. Besides, because the light-emitting unit emits the light continuously, the rays of different wavelengths can be generated in “real time” and transmitted to the light-sensing array by the spectroscopic unit, thereby improving the detection efficiency. Additionally, the light-sensing array senses the rays from the spectroscopic unit and forms an array spectrum which can be perceived with an intuitive detection result. For instance, by viewing the array spectrum (NIR glasses may be needed) or the pseudo colors corresponding to the array spectrum, the operator can know whether an abnormal tissue exists as well as the location and kind of the tissue.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical detection apparatus for detecting a tissue, comprising:
a light-emitting unit emitting light into the tissue;
a spectroscopic unit receiving the light outputted from the tissue and dividing the received light to output a plurality of rays with different wavelengths; and
a light-sensing array sensing the rays outputted from the spectroscopic unit so as to generate an array spectrum.

2. The optical detection apparatus as recited in claim 1, wherein the wavelength of the light emitted by the light-emitting unit ranges between 300 nm and 2000 nm.

3. The optical detection apparatus as recited in claim 1, further comprising:
a first light-guiding unit guiding the light emitted by the light mining unit to the tissue.

4. The optical detection apparatus as recited in claim 3, wherein the first light-guiding unit comprises at least one optical fiber.

5. The optical detection apparatus as recited in claim 1, wherein the spectroscopic unit comprises a spectroscopic prism, a filter unit, an acousto-optic tunable filter (AOTF) or a liquid crystal tunable filter (LCTF).

6. The optical detection apparatus as recited in claim 1, further comprising:
a second light-guiding unit guiding the light outputted from the tissue to the spectroscopic unit.

7. The optical detection apparatus as recited in claim 6 wherein the second light-guiding unit comprises a plurality of optical fibers.

8. The optical detection apparatus as recited in claim 1, wherein the light-sensing array comprises a plurality of light-sensing elements arranged in an array.

9. The optical detection apparatus as recited in claim 8, wherein the light-sensing element comprises a charge-coupled device or a complementary metal-oxide-semiconductor device.

10. The optical detection apparatus as recited in claim 1, wherein an axis of the array spectrum represents positions, and the other axis of the array spectrum represents wavelengths.

11. The optical detection apparatus as recited in claim 1, further comprising:
another spectroscopic unit receiving the light outputted from the tissue and thus dividing the received light into a plurality of rays with different wavelengths, which are transmitted to the light-sensing array or another light-sensing array.

12. The optical detecting apparatus as recited in claim 1, further comprising:
a tissue detection unit detecting the tissue.

13. The optical detection apparatus as recited in claim 1, further comprising:
a signal transforming unit receiving a light-sensing signal generated by the light-sensing array and transforming the light-sensing signal to a display signal.
